(19) United States
(12) Patent Application Publication
(10) Pub. No.: US 2023/0382288 A1
(43) Pub. Date: Nov. 30, 2023

(54) MODULAR TELESCOPIC COMPONENT CARRYING SYSTEM

(71) Applicant: Robert Devoe Peter, Saint Francis, WI (US)

(72) Inventor: Robert Devoe Peter, Saint Francis, WI (US)

(21) Appl. No.: 17/829,167

(22) Filed: May 31, 2022

(51) Int. Cl. B60P 7/08

(52) U.S. Cl. CPC B60P 7/0815

(57) ABSTRACT

The epitome of the invention is to provide secure attachment and easy removal and dedicated telescopic positioning of cargo. The embodiment of the invention is to provide an economical, convenient, and environmentally beneficial reuse of containers and cargo. The invention provides expanded cargo capabilities on or in any area or surface that holds cargo by assisting and enhancing cargo travel through the telescopic modular carrying and rail components. The invention further helps to curb typical cargo loss through dedicated attachment and detachment system of telescopic cargo rails and modules. The invention alleviates time-consuming, costly paraphernalia typical in cargo holds, relieves cargo failure, aiding in aseptic cargo holds. The invention creates integrated secure cargo connections for a convenient, reusable, economical, orderly, environmentally sustainable packaging. Furthermore, the invention creates ease of use for increased speed, simplicity, enhanced productivity, and increased profits in many areas of cargo carry.

### BACKGROUND OF INVENTION

The standards for transporting and securing cargo is generally completed by tie down, lashed, loose, chained, stacked and or banding cargo. This area of work and the application of this structural modular telescoping carrying system offers greater security, control, effective use, and ease of use in cargo holds, and the vertical or horizontal positions or any space that require cargo carrying. The embodiment of the invention relates generally to a structural particular modified dovetail modular telescopic component carrying system with removable, reusable particular rail and modular cargo hold components attaching, securing, protecting, and separating cargo. The further embodiment of the system is a simple easy to use, structure and method of removing or inserting cargo in fixed particular rails and modular components that easily maintain and enhance available cargo space, work area or carry structure through the inventions particular components. More particularly this embodiment enables the user to experience logistical ease of use and as well as providing aseptic protection of modular contained articles in or on a cargo holds area. The further exemplification of the invention relates to environmental benefits by reuse of structural modules providing healthier, convenient performance, and thereby alleviating harmful landfill use. The embodiment of the invention therefore decreases environmental impact through excessive use of materials and the attendant loss of cargo through typical hazards that impact users monetarily and environmentally. The invention greatly reduces labor involved in the associated tasks in the installation and removal of cargo in and on a container by dedicated connections to the male female particular telescoping rail system components. The essence of the invention further providing a way to maintain a regulated easily installed and removed restraint of cargo in many applications where a dedicated easy to use insertion and removal process of cargo carry is needed, The structural connective aspect comprising the inventions system maximizes containment area allowing for more usable cargo space and added benefits of the inventions connective additions, subtraction and reconfigurations through modular transformation. Whereby the embodiments comprising the invention perform multiple physical and monetary benefits for the consumer the invention further creates less environmental impact as well.

### DESCRIPTION

### Detailed Description of Drawings

The embodiment invention is constituted of male modified dovetail rail projections, female depressions and telescopically connecting with other male female protrusions and rail connections FIG. 1 extending from surfaces FIG. 2., and connecting modular cartons and decks FIG. 3., and posts FIG. 5., allowing particular member elements to attach and slide freely on the connecting rail projections and depressions FIG. 4, FIG. 5,. The distinct attendant modular cargo system components in the particular use and shape of the projection FIG. 2 the telescopic effect allows for insertion, addition, manipulation and subtraction of the peculiar modular components. FIG. 6. Shows multiple additional cargo module attachment enhancements, The male female telescopic configuration of cargo carton module utilizing the inventions participating female projection portion of the track rail systems modules is shown in FIG. 7 and FIG. 8 is another example of the particular cargo carrying modules. FIG. 9 is another view of the particular cargo carrying modules in place FIG. 10 is an overhead view of the particular cargo carrying modules and modular rail system in place. The distinct modular component multi directional grid that that the invention creates as an array of directional segment module rails in the inventions cargo carrying system is detailed FIG. 11. which supports particular modular decks and posts for variations of surfaces, and areas to connect and carry through the inventions modified dovetail telescopic component and particular male and female connections FIG. 12 is an overhead view of the inventions modular component multi directional grid. The invention also has for its object the provision for a secure separable cargo fastening and separable modules with the ability of extendable additional connectivity through telescopy add ons of particular modular components and reusable refillable cargo carton component modules that comprise the invention. A particular modular component with lid is shown to telescopically attach to the rail system shown in FIG. 13. Another view of the multi directional, vertically and horizontally is as a wall system shown in FIG. 14. Another view of the multi directional, vertically and horizontally adaptability of the invention is shown in FIG. 15 in relationship to a truck bed. The inventions particular rail and module containment and carrying system in modular rails details the inventions attachment of a deck attached to the inventions modular rail components in FIG. 16. A front view of the deck rail modified dovetail telescopic component carrying system FIG. 17. Shown in another view is the modular telescopic components system with attached deck that is the object of the invention in FIG. 18. The invention also has for its object the provision for a secure separable telescopic cargo fastening and separating telescopic modules with the added ability of extendable connectivity through telescopy and add on modular components. The invention further provides improved telescopic coupling means for cargo through peculiar modular components creating enhanced methods of attaching, replacing, and removing telescopically particliar modular cargo components logistically secured, organized, and regulated on the rail system in a cargo space, vertical surfaces, horizontal surfaces or area. Several alternative engagements in the male female dovetail telescopic configuration connect to the member structure in this modular rail system. The invention provides a method that allows attendant modular components to be inserted, removed from the particular cargo rails hold with ease through telescopic action. Using the cargo cartons, posts, and decks telescopically through the cargo carrying rail member system installing, removing, connecting, advancing, combining, containing, and securing the particular modular cargo components into the system members through the distinct connective modified dovetail male and female modules which are then guided to variable attachment and removal points. Along with the connecting telescopic dovetail male or female configuration other embodiments of the invention include attendant connective particular telescopic modules, cartons, decks, and posts using the various particular modular components which can be added, connected and removed to enhance the network usability, shape and size and will be described with reference to the accompanying drawings.

### BREIF DESCRIPTION OF DRAWINGS The listed several aspects, provisions, and advantages of the embodiment of the invention are comprised of:

FIG. 1. Modified dovetail rail projections Illustrates particular male/female modified dovetail connection projection

FIG. 2. Female depressions extending from surfaces for assorted insertions of particular cargo modules on a surface

FIG. 3. Connected telescoping modular cartons

FIG. 4. Female and male connections showing additional particular carton modules carrying capacity through connectivity for extension purposes.

FIG. 5. A view of a connected telescoping modular carton

FIG. 6. Is a view of the modified dovetail rail systems telescopic modules in variations of connections and configurations super imposed over others in place comprising a versionthe inventions system.

FIG. 7. Is a plan of the modular component telescopic modular carton in place on the inventions rail modular component

FIG. 8. Is another view of the modular component telescopic modular carton in place on the inventions rail modular component

FIG. 9. Shows a view of a version of the inventions modular telescopic components in place in a cargo hold that further shows the object of the invention

FIG. 10. Shows a overhead view of a version of the inventions modular telescopic components in place in a cargo hold that further shows the object of the invention

FIG. 11 Depicts an array of directional segmented particular module rails in a detailed cargo area.

FIG. 12 is an overhead view of the inventions modular component multi directional grid

FIG. 13. Another view of the multi directional, vertically and horizontally is as a wall system

FIG. 14. Another view of the multi directional, vertically and horizontally adaptability of the invention

FIG. 15. Shows the multi directional, vertically and horizontally adaptability of the invention in relationship to a truck bed.

FIG. 16. A front view of the deck rail modified dovetail telescopic component carrying system

FIG. 17. Shows a view of the inventions particular rail and module containment with a deck attached to modular rail components.

FIG. 18. Showing another perspective of the modified dovetail telescopic modular components as a system that is the object of the invention.

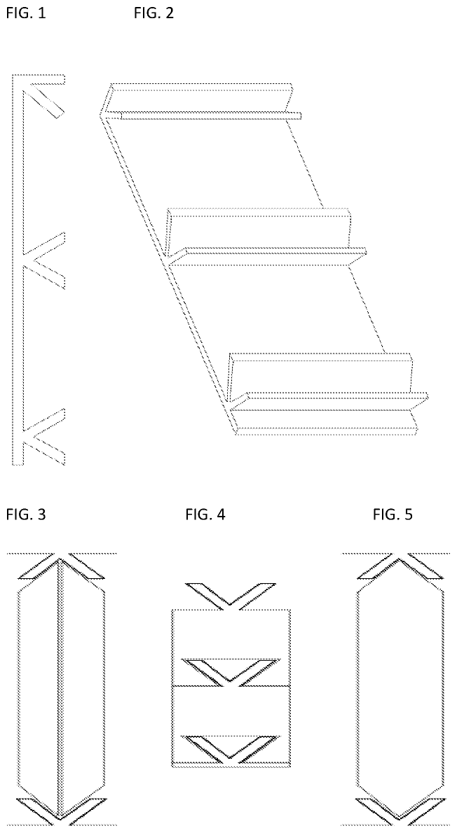

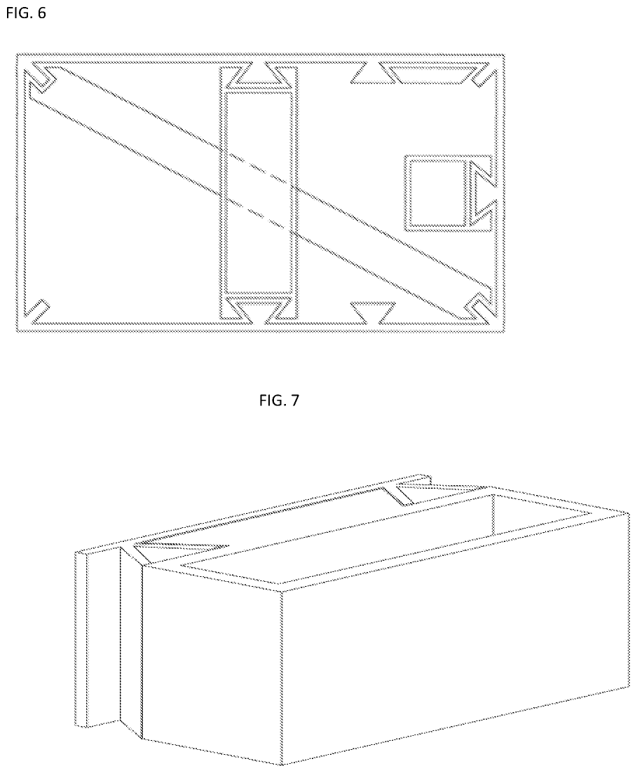

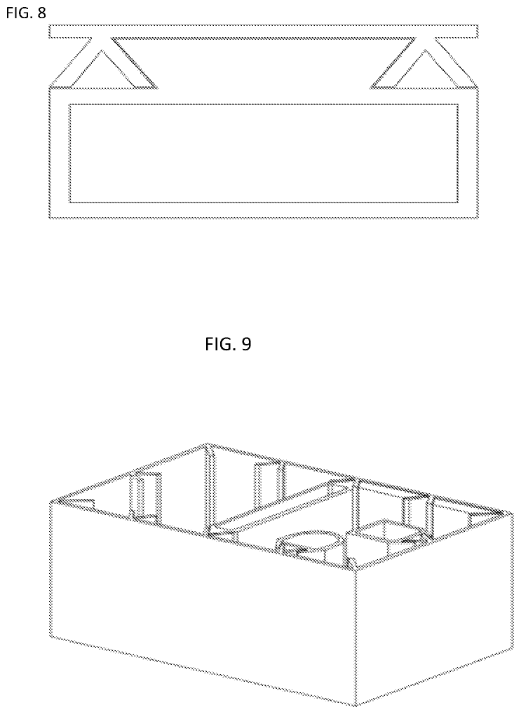

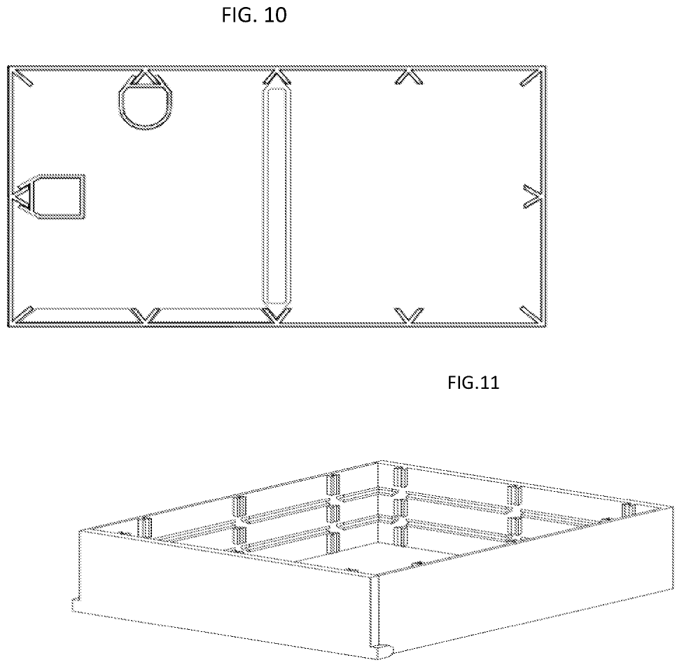

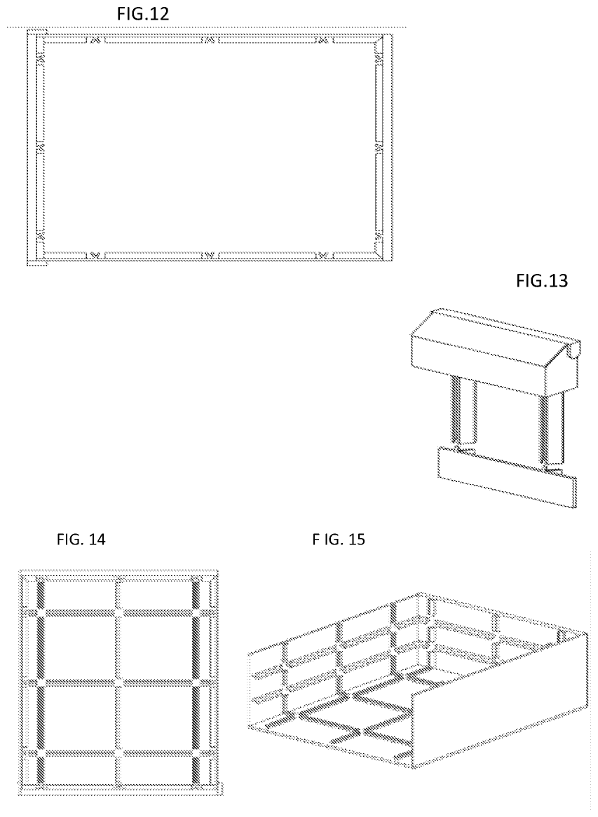

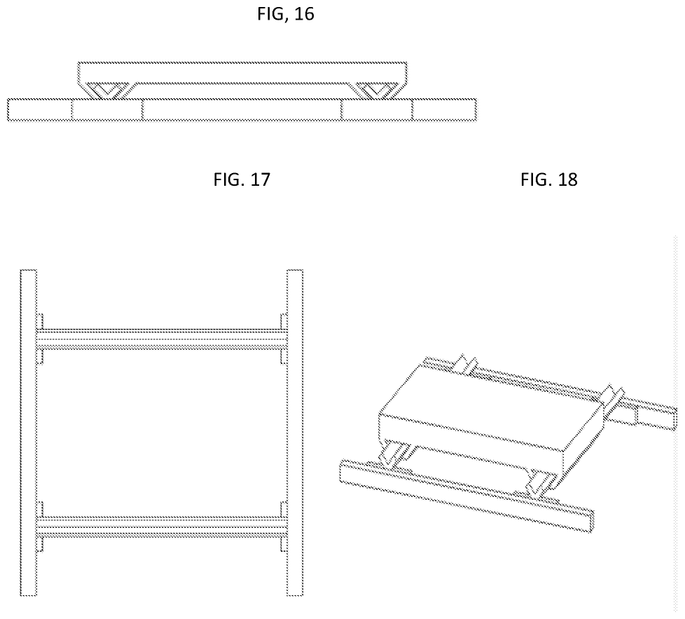

### SUMMARY

The embodiment of the invention is to provide secure attachment and easy removal of cargo. The further embodiment of the invention is to provide an economical, convenient environmentally beneficial reuse of containers and cargo in a particular containment area. The invention further physically enhances container space or surface where logistical arrangement is relavent. The further embodiment of the invention provides profound expanded realized space in a confined compartment as well as any area or surface that houses or hold cargo by assisting and enhancing cargo attachments of any cargo through the particular telescopic modular rail or cargo components of the invention. The invention further helps to easily curb typical cargo loss through facilitating easy dedicated attachment and detachment of cargo in numerous arenas telescopically. The invention further alleviates the need for time-consuming, costly, extraneous attachment paraphernalia typical in cargo holds through the inventions particular integrated telescopic modular cargo containers and rail components. The architectonic attachment system via distinct physical positioning relieves cargo failure, aids in aseptic, hygienic cargo holds and the attendant cleanup of those instances. The added embodiment of the invention is integrated secure cargo connections make the invention a convenient, reusable, economically orderly structural and environmentally valuable modular telescopic component system adding to increased productivity and increased profits. Use of the invention creates significant ease of cargo use through logistically allowing increased speed, simplicity, creating attachments constructing efficient and secure removal and replacement of these telescopic modular components in orderly connected cargo containment. The reusable aspect of the invention's particular cargo modules creates an environmentally sound benefit a fact that should not be dismissed in the scope and relevance of the invention, I. E. fixed replaceable ice packs in a cooler structure eliminating the need for disposable ice bags and attendant loss of material, food, and water. Consider the impact of solid ice cubes turning into melting ice and ultimately water sloshing in your cooler with your soggy sandwich in that pool. That is loss in several ways, loss of water, sandwich, and the need to discard the plastic and other attendant waste. In that way the invention decreases landfill use and the environmental impact of unnecessary waste as well as the attendant need to acquire more non reusable containers. The invention further enhances the logistical placement of items that may otherwise fail in shipment using the inventions logistically fixed structural rails in and around an area as well as creating expanded usable space for more economical success in transport of cargo with the inventions particular modular carrying components as in reconfiguring a back pack frame through the inventions embodiments, or a car top carriers application of the rail grid system to enhance the usability through telescopic modular connectivity and enhanced carry capacity through use of the inventions logistical modular telescopic system. Many fields can be assisted in the use of the inventions modular telescopic component carrying system creating safe, efficient, reusable material handling.

1. It is to be said while certain preferred embodiments of the present invention have been disclosed in detail, it is to be understood that various modifications may be adopted without departing from the spirit of the invention or scope of the following claims.
While the foregoing details what is felt to be the preferred embodiment of the invention, no material limitations to the scope of the claimed invention are intended. The invention furthered features and design alternatives that would be obvious to one of ordinary skill in the art are considered to be incorporated herein. Exemplary alternatives considered incorporated herein, though not limited thereto-specific physical geometries that are not essential to the overall operation of the embodiment. The scope of the invention is set forth and particularly described in the claims herein below.
The listed are the several aspects, provisions, and advantages of the embodiment of the invention are comprised of:
An invention as an integral structural and containment system comprising of the dedicated distinct connectors for particular telescopic modular components and the attendant particular rail system supporting the particular modular cargo components for containment of cargo the invention consists of the particular parts that encompass the advantages of the invention.
An adjustable telescopic cargo carrying and containing system with respect to other member components maintaining the integrity of cargo that comprises the invention.
A system consisting of removable, stackable, reusable components dedicated to that secure and movable attachment of the inventions particular interchangeable modular telescopic containment components along the inventions attendant convenient rail arrangement.
The invention provides a method that allows attendant modular components to be inserted, removed from the particular cargo hold rails with ease through telescopic action.
The invention as a attachable system to attach additional components telescopically as well as through structural positioning of modular rail components to enhance the size and scope of the systems usability.
The invention accommodates through systemic convenient operation of cargo transfer through the logistically ordered aspects that comprise the invention as a regulated modular telescoping component containment system.
The invention also provides the benefits of enhanced environmental sustainability through loss containment and reuse of modular components in the operation of commercial, travel and leisure activities alleviating cargo loss and avoiding additional component acquisition through the reusable particular modular components.
The invention amounts to the enhanced economic benefit in alleviating use of new components thereby the invention aids by limiting the need of disposables and the negative attendant commercial and personal fiscal economies of unnecessary acquisition of additional cargo containers, lost space, environmental waste and attendant extraneous waste.
As fundamental aspects of the invention it constitutes enhanced economic, physical and health benefits through elimination of inadvertent cargo loss using the structural modular components of the invention through dedicated particular telescopic attachments that comprise the systemic advantage of the invention.
An invention that establishes enhanced user satisfaction, enhanced convenience and experience through ease of use in installation, reuse of particular modular components, and usability in removal of those particular modular components attachments.
The invention is a structural modular telescopic component cargo containment system comprised through utilizing interlocking coupling connections. The invention safely and easily maintains regulated fixed and readily removed particular modular cargo telescopic components. The invention has the added ability and advantage to contain non systemic cargo in the system structure through particular attachments for enhanced convenience. Furthermore the invention allows through its structural containment, enhanced loss prevention of parcels and reuse of materials through features listed features above as the inventions objective.
